(19) United States
(12) Patent Application Publication
(10) Pub. No.: US 2026/0086648 A1
(43) Pub. Date: Mar. 26, 2026

(54) PROJECTION DEVICE AND A CONTROL METHOD THEREOF

(71) Applicant: Coretronic Corporation, Hsin-Chu (TW)

(72) Inventors: Yu-Chi WU, Hsin-Chu (TW); Yu-Chun CHEN, Hsin-Chu (TW)

(21) Appl. No.: 19/260,623

(22) Filed: Jul. 7, 2025

(30) Foreign Application Priority Data
Sep. 20, 2024 (TW) 113135851

(51) Int. Cl. G06F 3/01; H04N 9/31

(52) U.S. Cl. CPC G06F 3/017; H04N 9/31

(57) ABSTRACT

A projection device including an identification module, a determining unit, a control module, an interface module, a signal processing module, a projection module and an audio module is provided. The identification module generates identification sensing data. The determining unit receives the identification sensing data in response to the projection device implementing a gesture identification function, identify a gesture content based on the identification sensing data, and generate a control instruction based on the gesture content. The control module determines a command channel object of the control instruction. The interface module receives input data and the control instruction. The signal processing module receives the control instruction and the input data, generates at least one of projection data and audio data based on the control instruction and the input data. The projection module receives the projection data and provides an image beam. The audio module receives the audio data and outputs sound.

### CROSS-REFERENCES

This application claims the priority benefit of Taiwan Patent Application Serial Number 113135851 filed on Sep. 20, 2024, the full disclosure of which is incorporated herein by reference.

### TECHNICAL FIELD

The disclosure is related to the field of projection technology. More particularly, the embodiments are related to a projection device and a control method thereof.

### DESCRIPTION OF RELATED ART

A projection device (such as a projector) is a display device that converts image data from an external signal source into an image beam. Since an image can be displayed by simply projecting the image beam onto any surface, the projection device is widely used in various scenarios.

Generally, if a user wants to adjust an external signal source (such as changing image data, playing sound effects, etc.), the user needs to use a control device (such as a mouse, keyboard, laser pen, touch panel, etc.) that is connected to the external signal source to control the external signal source. Furthermore, if the user wants to set the brightness, volume, input source, etc. of the projection device, the user usually executes the setting of the projection device through the buttons of the projection device or the remote control. The abovementioned setting method makes inconvenience.

The information disclosed in this DESCRIPTION OF RELATED ART section is only for enhancement of understanding of the background of the described technology and therefore it may contain information that does not form the prior art that is already known to a person of ordinary skill in the art. Further, the information disclosed in the DESCRIPTION OF RELATED ART section does not mean that one or more problems to be resolved by one or more embodiments of the disclosure was acknowledged by a person of ordinary skill in the art.

### SUMMARY OF THE INVENTION

The embodiment of the disclosure provides a projection device and a control method thereof to allow users to easily control or adjust the settings of the projection device and the external signal source that provides image data through changes in gestures.

In order to achieve the above object and other related objects, the disclosure provides a projection device that is electrically connected to a signal source. The projection device includes an identification module, a determining unit, a control module, an interface module, a signal processing module, a projection module and an audio module. The identification module is configured to generate identification sensing data. The determining unit is electrically connected to the identification module. The determining unit is configured to receive the identification sensing data in response to the projection device implementing a gesture identification function, and identify a gesture content based on the identification sensing data, and generate a control instruction based on the gesture content. The control module is electrically connected to the determining unit. The control module is configured to receive the control instruction and determine a command channel object of the control instruction. The interface module is electrically connected to the control module and the signal source. The interface module is configured to receive an input data from the signal source. The interface module is configured to receive the control instruction from the control module and transmit the control instruction to the signal source to enable the signal source to operate according to the control instruction. The signal processing module is electrically connected to the control module and the interface module. The signal processing module is configured to receive the control instruction from the control module and the input data from the interface module, and to generate at least one of projection data and audio data based on the control instruction and the input data. The command channel object is at least one of the interface module and the signal processing module. The projection module is electrically connected to the signal processing module. The projection module is configured to receive the projection data and provide an image beam based on the projection data. The audio module is electrically connected to the signal processing module. The audio module is configured to receive the audio data and output sound based on the audio data.

In one embodiment, the projection device includes a status detection module. The status detection module is electrically connected to the control module. The status detection module is configured to generate status detection data. The control module receives the status detection data and determines, based on the status detection data, whether the projection device implements the gesture identification function or an eye protection function. In response to the projection device implementing the gesture identification function, at least one of the projection data and the audio data includes notification data and the notification data indicates that the function of the control instruction is completed. In response to the projection device implementing the eye protection function, the determining unit identifies a corresponding distance content based on the identification sensing data, and the determining unit generates the control instruction based on the distance content.

In one embodiment, the control module receives the status detection data and determines, based on the status detection data, whether the status of the projection device is a hanging mode or a forward projection mode. In response to the status of the projection device being the hanging mode, the control module is configured to allow the projection device to implement the gesture identification function.

In one embodiment, in response to the projection device being in the forward projection mode, the control module determines whether the projection device implements the gesture identification function or the eye protection function based on a function setting information.

In one embodiment, the status detection module is an acceleration sensor, a gyroscope or a gravity sensor.

In one embodiment, the identification module includes a gesture identification module and an eye protection identification module. The gesture identification module is electrically connected to the determining unit, and the gesture identification module is configured to generate gesture identification sensing data. The eye protection identification module is electrically connected to the determining unit, and the eye protection identification module is configured to generate distance identification sensing data. In response to the projection device implementing the gesture identification function, the determining unit receives the gesture identification sensing data. In response to the projection device implementing the eye protection function, the determining unit receives the distance identification sensing data.

In one embodiment, the gesture identification module and the eye protection identification module are the same identification module. The identification sensing data generated by the identification module are the gesture identification sensing data or the distance identification sensing data.

In one embodiment, the identification module includes a first sensing unit and a second sensing unit. A horizontal connection line is defined between the first sensing unit and the second sensing unit. Sensing areas of the first sensing unit and the second sensing unit are at least partially non-overlapping. The determining unit is configured to identify the gesture content according to distance data, the distance data corresponds to a distance between an object and the first sensing unit and a distance between the object and the second sensing unit respectively.

In one embodiment, the identification module includes a third sensing unit. The third sensing unit is not disposed on the horizontal connection line, and the sensing areas of the first sensing unit, the second sensing unit and the third sensing unit at least partially overlap.

In one embodiment, the determining unit is configured to perform a linear transformation on the distance data of the object and the first sensing unit, the object and the second sensing unit and the object and the third sensing unit to obtain coordinates of the object.

In one embodiment, the identification module includes one or more single area sensing units or multi-area sensing units.

In one embodiment, each of the identification sensing data is distance data. The determining unit identifies the gesture content based on the distance data in different time series.

In one embodiment, the signal processing module includes an image processing module and an audio processing module. The image processing module is electrically connected to the control module, the interface module, and the projection module. The image processing module receives the control instruction from the control module and the input data from the interface module and generates the projection data based on the control instruction and the input data. The audio processing module is electrically connected to the control module, the interface module and the audio module. The audio processing module receives the control instruction from the control module and the input data from the interface module and generates the audio data based on the control instruction and the input data.

In one embodiment, the interface module includes a front-end processor and an interface terminal. The front-end processor is electrically connected to the control module and the signal processing module. The front-end processor is configured to receive the control instruction from the control module and the input data from the signal source and also to preprocess the input data. The interface terminal is electrically connected to the front-end processor and the signal source. The interface terminal transmits the control instruction from the control module to the signal source and transmits the input data from the signal source to the front-end processor.

In one embodiment, the projection data generated by the signal processing module includes object selection data. The object selection data includes a plurality of options. In response to the gesture content corresponding to one of the options, the projection data includes notification data. The notification data indicate that the option is selected, and the control instruction corresponds to the selected option.

In order to achieve the above object and other related objects, the disclosure provides a control method for a projection device. The control method is applied to the projection device. The projection device is electrically connected to a signal source. The projection device includes a determining unit, a control module, an interface module, a signal processing module, a projection module and an audio module. The control method includes the following steps: in response to the projection device implementing a gesture identification function, the determining unit identifying a gesture content based on identification sensing data and generating a control instruction based on the gesture content; determining a command channel object of the control instruction through the control module, wherein the command channel object is at least one of the interface module and the signal processing module; receiving input data from the signal source by the interface module and transmitting the control instruction to the signal source through the interface module to enable the signal source to operate according to the control instruction; generating at least one of projection data and audio data through the signal processing module based on the input data and the control instruction; providing an image beam base on the projection data through the projection module; and outputting sound based on the audio data through the audio module.

In one embodiment, the projection device includes a status detection module. The control method includes the following steps: generating status detection data through the status detection module; determining whether the projection device implements the gesture identification function or an eye protection function based on the status detection data through the control module; in response to the projection device implementing the gesture identification function, a function of the control instruction is indicated by notification data, wherein at least one of the projection data and the audio data comprises the notification data; in response to the projection device implementing the eye protection function, the determining unit identifies a corresponding distance content based on the identification sensing data and generates the control instruction based on the distance content.

In one embodiment, in response to the control module determining the projection device in the hanging mode based on the status detection data, the control module determines the projection device to implement the gesture identification function. In response to the control module determining the projection device in the forward projection mode based on the status detection data, the control module determines the projection device to implement the gesture identification function or the eye protection function based on the function setting information.

In one embodiment, the control method further includes the following steps: identifying the gesture content based on distance data of the identification sensing data in different time series through the determining unit.

In one embodiment, the control method further includes the following steps: identifying the gesture content according to distance data of an object and a first sensing unit and distance data of the object and a second sensing unit respectively through the determining unit.

In one embodiment, the control method further includes the following steps: obtaining coordinates of the object by performing a linear transformation on the distance data of the object and the first sensing unit, the distance data of the object and the second sensing unit and distance data of the object and a third sensing unit respectively through the determining unit.

In one embodiment, the control method further includes the following steps: generating the projection data based on the input data and object selection data through the signal processing module, wherein the object selection data comprises a plurality of options; providing the image beam based on the projection data through the projection module; in response to one of the options corresponding to the gesture content is obscured, generating the control instruction based on the gesture content through the determining unit.

In one embodiment, the control method further includes the following steps: in response to the command channel object being the interface module, the signal source updates the input data corresponding to the control instruction.

According to the above, the embodiments of the disclosure at least include one of the following beneficial effects: The projection device and the control method according to the embodiment of the invention allow the user to easily control or adjust the settings of the projection device and the external signal source that provides image data through gesture changes.

Other objectives, features and advantages of the invention will be further understood from the further technological features disclosed by the embodiments of the invention, wherein there are shown and described preferred embodiments of this invention, simply by way of illustration of modes best suited to carry out the invention.

### BRIEF DESCRIPTION OF DRAWINGS

FIG. 1 is a schematic of a projection device according to an embodiment of the disclosure.

FIG. 2 is a schematic of the relative positions of sensing units according to an embodiment of the disclosure.

FIG. 3 is a schematic of the relative positions of sensing units and a projection target according to an embodiment of the disclosure.

FIG. 4 is a schematic of the relationship between the sensing areas of sensing units and the projection area of a projected image according to an embodiment of the disclosure.

FIG. 5 is a schematic of the relative positions of sensing units and a projection target according to an embodiment of the disclosure.

FIG. 6 is a schematic of the relationship between the sensing areas of sensing units and projection area of a projected image according to an embodiment of the disclosure.

FIG. 7 is a schematic of the relative positions of sensing units according to an embodiment of the disclosure.

FIG. 8 is a schematic of the relative positions of sensing units and a projection target according to an embodiment of the disclosure.

FIG. 9 is a schematic of the relationship between the sensing areas of sensing units and the projection area of a projected image according to an embodiment of the disclosure.

FIG. 10 is a schematic of an identification sensing data according to an embodiment of the disclosure.

FIG. 11 is a schematic of an identification sensing data according to another embodiment of the disclosure.

FIG. 12 is a schematic of an interactive control situation according to an embodiment of the disclosure.

FIG. 13 is a schematic of an interactive control situation according to another embodiment of the disclosure.

FIG. 14 is a schematic of an interactive control situation according to another embodiment of the disclosure.

FIG. 15 is a schematic of a notification data according to an embodiment of the disclosure.

FIG. 16 is a schematic of a flow chart of a control method of a projection device according to an embodiment of the disclosure.

FIG. 17 is a schematic of a flow chart of a control method of a projection device according to an embodiment of the disclosure.

### DESCRIPTION OF THE INVENTION

It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, “having” and variations thereof herein is meant to encompass the items listed thereafter and equivalents thereof as well as additional items. Unless limited otherwise, the terms “connected”, “coupled”, “mounted” and variations thereof herein are used broadly and encompass direct and indirect connections, couplings, and mountings.

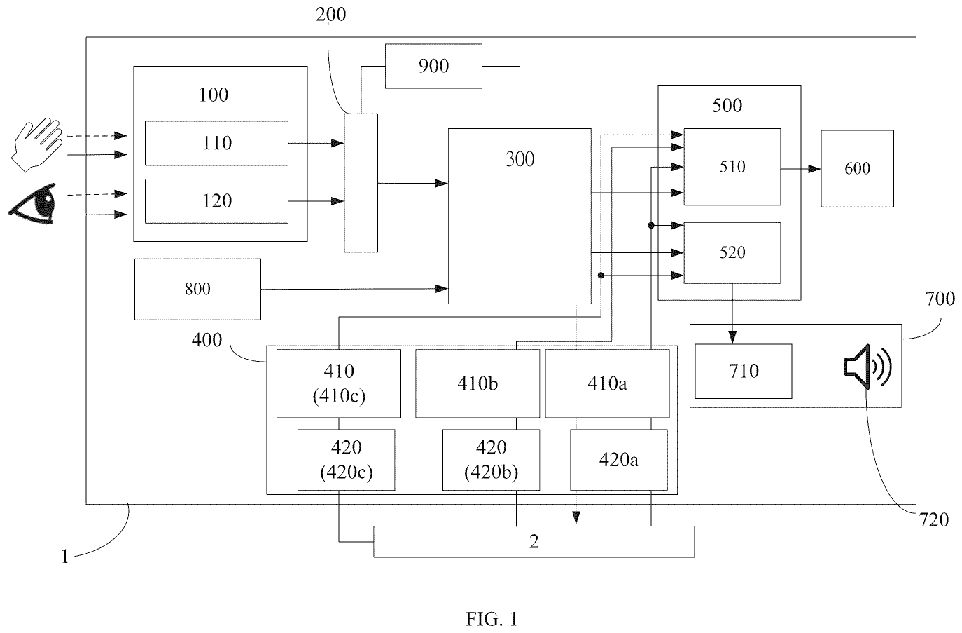

Please refer to FIG. 1. FIG. 1 is a schematic of a projection device according to an embodiment of the disclosure. A projection device 1 is electrically connected to a signal source 2. The projection device 1 is, for example, a projector. The signal source 2 is, for example, a notebook computer, a desktop computer, a tablet computer, a smart phone, an audio-visual player, a digital set-top box or other electronic devices. The projection device 1 is used to receive input data from the signal source 2 and generate image beam and/or audio data based on the input data. The input data are, for example, input image data and/or input audio data. The projection device 1 is used to project the image beam to a projection target (such as a wall, desktop or projection screen) and generate a projected image corresponding to the image beam on the projection target.

The projection device 1 includes an identification module 100, a determining unit 200, a control module 300, an interface module 400, a signal processing module 500, a projection module 600 and an audio module 700. The identification module 100 is used to generate identification sensing data sequentially over time. The identification sensing data is distance data. When the projection device 1 is operating, the identification module 100 continuously senses the distance between an object and the identification module 100 to generate the identification sensing data. The determining unit 200 is electrically connected to the identification module 100. In response to the projection device 1 implementing a gesture identification function, the determining unit 200 is used to receive identification sensing data (such as the distance data) from the identification module 100, identify a gesture content based on the identification sensing data, and generate a control instruction based on the identified gesture content. The control module 300 is electrically connected to the determining unit 200. The control module 300 is used to receive the control instruction and determine a command channel object of the control instruction. The command channel object is at least one of the interface module 400 and the signal processing module 500. The interface module 400 is electrically connected to the signal processing module 500 and the signal source 2. The interface module 400 is used to receive the input data from the signal source 2 and to provide the input data to the signal processing module 500. In one embodiment, the interface module 400 is electrically connected to the control module 300, and the interface module 400 is used to receive the control instruction from the control module 300 and to transmit the control instruction to the signal source 2. Thus, the signal source 2 might operate in response to the control instruction. The signal processing module 500 is electrically connected to the control module 300 and the interface module 400. The signal processing module 500 is used to receive the control instruction from the control module 300 and the input data from the interface module 400. The signal processing module 500 generates at least one of projection data and the audio data based on the received control instruction and input data. The projection module 600 is electrically connected to the signal processing module 500. The projection module 600 is used to receive the projection data from the signal processing module 500 and to provide the image beam based on the projection data. The projection module 600 includes components such as a light source, a light valve, and a projection lens. The light source may include at least one of a light emitting diode and a laser diode. The light valve may be a digital micromirror device (DMD) or a liquid crystal panel. A projection lens may comprise a plurality of lenses. The audio module 700 is electrically connected to the signal processing module 500. The audio module 700 is used to receive the audio data from the signal processing module 500 and output sound based on the received audio data.

Each of the determining unit 200, the control module 300 and the signal processing module 500 may be, for example, one or more processors with computing capabilities, or a hardware circuit that may be configured by a hardware description language (HDL) or any other digital circuit design methods that are familiar to a person having ordinary skill in the art and implemented through at least one microprocessor, at least one GPU, at least one CPU, a field programmable gate array (FPGA), a complex programmable logic device (CPLD) or an application-specific integrated circuit (ASIC) (such as a distributed data processor (DDP)). The determining unit 200, the control module 300 and the signal processing module 500 may be disposed in a same system on a chip (SOC).

In one embodiment, the identification module 100 may be used to allow the projection device 1 to implement the gesture identification function, an eye protection function or a focus mode. Thus, the projection device 1 may identify the user's gesture content through the identification module 100, adjust the projection data and/or audio data based on the gesture content, and control the operation of the signal source 2 based on the gesture content. Therefore, controlling the projection device 1 and/or the signal source 2 through the gesture content may be implemented.

In one embodiment, the identification module 100 includes a gesture identification module 110 and an eye protection identification module 120. The gesture identification module 110 is electrically connected to the determining unit 200. The gesture identification module 110 is used to sense the distance between it and the object and to generate the gesture identification sensing data according to the sensed distance. The eye protection identification module 120 is electrically connected to the determination unit 200. The eye protection identification module 120 is used to sense the distance between it and the object and to generate distance identification sensing data according to the sensed distance. The object may be the user's hand or an item held by the user (for example, a pointing stick). In one embodiment, the gesture identification module 110 may be a Passive Infra-Red (PIR) sensor or a Time of Flight (TOF) sensor. In one embodiment, the eye protection identification module 120 may be a Passive Infra-Red (PIR) sensor or a Time of Flight (TOF) sensor. In one embodiment, the gesture identification module 110 and/or the eye protection identification module 120 may be implemented by one or more single area sensing units or multi-area sensing units. The single area sensing unit is, for example, a Passive Infra-Red (PIR) sensor. The identification sensing data is numerical data. Numerical data are, for example, voltage value data. The multi-area sensing unit is, for example, a Time of Flight (TOF) sensor. The identification sensing data are a depth image data. When the projection device 1 implements the gesture identification function, the determining unit 200 receives the gesture identification sensing data. When the projection device 1 implements the eye protection function, the determining unit 200 receives the distance identification sensing data. In one embodiment, the gesture identification module 110 and the eye protection identification module 120 may be the same identification module. The gesture identification module 110 and the eye protection identification module 120 may be executed by the same sensing unit. Therefore, the identification sensing data generated by the identification module 100 may be the gesture identification sensing data or the distance identification sensing data. In other embodiments, the gesture identification module 110 and the eye protection identification module 120 may be different identification modules. Therefore, the projection device 1 may implement the eye protection function and gesture identification function at the same time. For example, in one embodiment, the identification module 100 may comprise at least one of Passive Infra-Red (PIR) sensor or at least one of Time of Flight (TOF) sensor. In one embodiment, the identification module 100 may comprise at least one of Passive Infra-Red (PIR) sensor and at least one of Time of Flight (TOF) sensor.

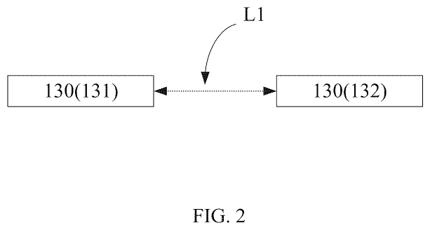

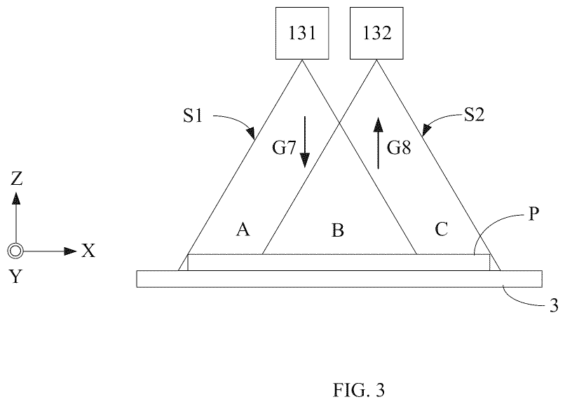

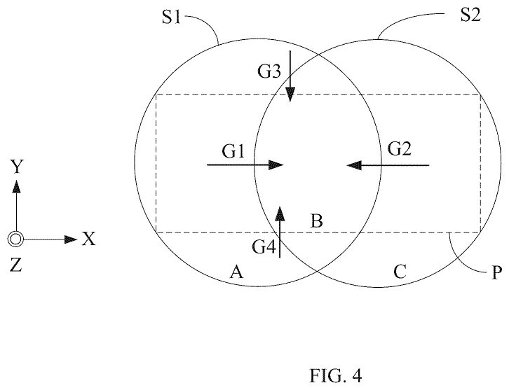

Please refer to FIG. 2, FIG. 3 and FIG. 4. FIG. 2 is a schematic of the relative positions of sensing units according to an embodiment of the disclosure. FIG. 3 is a schematic of the relative positions of sensing units and a projection target according to an embodiment of the disclosure. FIG. 4 is a schematic of the relationship between the sensing areas of sensing units and the projection area of a projected image according to an embodiment of the disclosure. In FIG. 3 and FIG. 4, a first axis X, a second axis Y, and a third axis Z that are perpendicular to each other are shown. A projection target 3 is, for example, a projection screen or a projection surface. The identification module 100 may include at least one sensing unit 130. The sensing unit 130 may be implemented by, for example, the aforementioned single area sensing unit. For example, the sensing unit 130 (a first sensing unit 131, a second sensing unit 132 or a third sensing unit 133) may be a Passive Infra-Red (PIR) sensor or a Time of Flight (TOF) sensor. The at least one sensing unit 130 is configured on the projection device 1 and is disposed toward the projection target 3. The sensing area of the at least one sensing unit 130 and a projection area P of the projected image at least partially overlap. When the object is located between the at least one sensing unit 130 and the projection target 3 and falls in the sensing area of the at least one sensing unit 130, the at least one sensing unit 130 generates corresponding identification sensing data (distance data) based on the distance between the object and the at least one sensing unit 130. In one embodiment, the identification module 100 may include a first sensing unit 131 and a second sensing unit 132. The first sensing unit 131 and the second sensing unit 132 are located on the same side of the projection device 1 and are arranged along the first axis X direction. There is a horizontal connection line L1 (parallel to the first axis X) between the first sensing unit 131 and the second sensing unit 132. The first sensing unit 131 has a sensing area S1. The second sensing unit 132 has a sensing area S2. The sensing areas S1 and S2 of the first sensing unit 131 and the second sensing unit 132 do not overlap at least partially. The non-overlapping areas of the sensing area S1 and sensing area S2 are, for example, area A and area C, and the overlapping areas are, for example, area B. In other embodiments, the sensing area S1 of the first sensing unit 131 and the sensing area S2 of the second sensing unit 132 may not overlap at all. In the embodiment, area A, area B and area C formed by the sensing areas S1 and S2 of the first sensing unit 131 and the second sensing unit 132 may be arranged along the first axis X direction.

In one embodiment, the determining unit 200 identifies the gesture content based on identification sensing data in different time sequences. Please refer to FIGS. 1 to 4. In response to the projection device 1 implementing the gesture identification function, the determining unit 200 identifies the gesture content according to the identification sensing data of the object and at least one sensing unit 130 and generates the control instruction based on the gesture content. In the embodiment where the object moves laterally or longitudinally, the determining unit 200 receives identification sensing data corresponding to the distance between the object and the first sensing unit 131 (second sensing unit 132) from the first sensing unit 131 (second sensing unit 132) at a first time sequence. The determining unit 200 receives identification sensing data corresponding to the distance between the object and the second sensing unit 132 (first sensing unit 131) from the second sensing unit 132 (first sensing unit 131) at a second time sequence later than the first time sequence. The determining unit 200 determines that the object moves from the sensing area S1 of the first sensing unit 131 to the sensing area S2 of the second sensing unit 132 or moves from the sensing area S2 of the second sensing unit 132 to the sensing area S1 of the first sensing unit 131 based on the time sequence, the identification sensing data and the source (first sensing unit 131 or sensing area S2) of the identification sensing data. Therefore, the determination unit 200 may identify the gesture content. The determining unit 200 further determines the corresponding instruction category based on the gesture content. For example, the gesture content that moves laterally corresponds to an instruction category of reducing the volume of the projection device 1. The determining unit 200 generates the control instruction based on the instruction category and provides the control instruction to the control module 300.

For example, in an embodiment in which the object moves laterally (along the direction parallel to the first axis X), the object is first located in area A, and the determining unit 200 only receives by the first sensing unit 131 in the first time sequence the identification sensing data corresponding to the distance between the object and the first sensing unit 131, and this condition may last for a specific time. In the second time sequence, the object moves to area B, and the determining unit 200 receives the identification sensing data corresponding to the distances between the object and the first sensing unit 131 and the second sensing unit 132 (simultaneously) from the first sensing unit 131 and the second sensing unit 132 respectively. In the third time sequence, the object moves to area C, so the determining unit 200 only receives the identification sensing data corresponding to the distance between the object and the second sensing unit 132 from the second sensing unit 132. The identification sensing data received by the determining unit 200 in the first time sequence, the second time sequence and the third time sequence are distance data with different values. The determining unit 200 determines that the object moves from the sensing area S1 of the first sensing unit 131 to the sensing area S2 of the second sensing unit 132 based on the time sequence, identification sensing data and the source of the identification sensing data. Therefore, the determination unit 200 identifies the gesture content G1 of lateral movement. Then the determining unit 200 determines the corresponding instruction category based on the gesture content G1, generates a control instruction based on the instruction category, and provides the control instruction to the control module 300. In the embodiment, the gesture content G1 may correspond to the sensing unit 130 detecting that the object moves from area A to area B or area C. or moves from area B to area C. In the embodiment, the gesture content G2 may correspond to the detection unit 130 detecting that the object moves from area C to area B or area A, or moves from area B to area A.

For example, in an embodiment in which the object moves longitudinally (along the direction parallel to the second axis Y), the difference between the embodiment of the object moves laterally and moves longitudinally is that the object is first located in area A, the object moves to area B in the second time sequence, and the object moves to area A again in the third time sequence. The determining unit 200 only receives the identification sensing data from the first sensing unit 131 in the third time sequence. The determining unit 200 determines that the object moves from area A to area B and then returns to area A. The determining unit 200 identifies a gesture content G3 of longitudinal movement. In the embodiment, the gesture content G3 may correspond to the sensing unit 130 at least detecting that the object moves from area A to area B, or that the object moves from area B to area A. In the embodiment, the gesture content G4 may correspond to the detection unit 130 at least detecting that the object moves from area C to area B, or that the object moves from area B to area C.

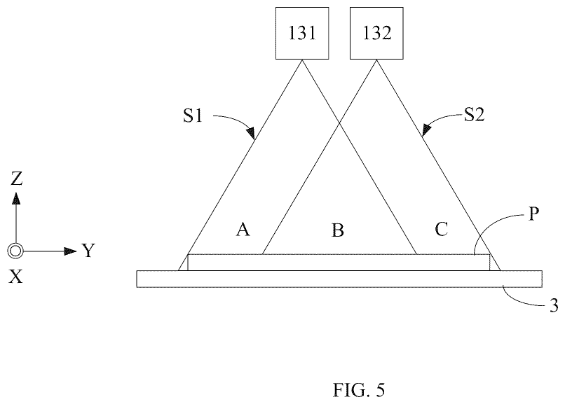

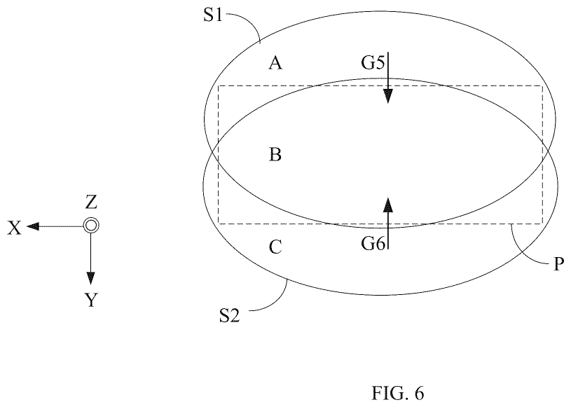

Please refer to FIG. 5 and FIG. 6. FIG. 5 is a schematic of the relative positions of sensing units and a projection target according to an embodiment of the disclosure. FIG. 6 is a schematic of the relationship between the sensing areas of sensing units and projection area of a projected image according to an embodiment of the disclosure. The difference between FIG. 5 and FIG. 3 is that the first sensing unit 131 and the second sensing unit 132 of FIG. 5 are arranged along the second axis Y. As shown in FIG. 6, the area A, area B and area C formed by the sensing area S1 of the first sensing unit 131 and the sensing area S2 of the second sensing unit 132 may be arranged along the second axis Y direction.

In the embodiment in FIG. 6, the object moves longitudinally (along the direction parallel to the second axis Y); the difference between the embodiments in FIG. 4 and FIG. 6 is that the object is first located in area A in the first time sequence, the object moves to area B in the second time sequence, and the object moves to area C in the third time sequence. The determining unit 200 only receives the identification sensing data corresponding to the distance between the object and the second sensing unit 132 from the second sensing unit 132 in the third time sequence. The determining unit 200 determines that the object moves from the sensing area S1 of the first sensing unit 131 to the sensing area S2 of the second sensing unit 132. Therefore, the determining unit 200 identifies the gesture content G5 of longitudinal movement. In the embodiment, the gesture content G5 may correspond to the sensing unit 130 detecting that the object moves from area A to area B or area C, or that the object moves from area B to area C. In the embodiment, the gesture content G6 may correspond to the sensing unit 130 detecting that the object moves from area C to area B or area A, or that the object moves from area B to area A.

In the embodiment where the object moves forward and backward (as shown in FIG. 3), the determining unit 200 sequentially receives identification sensing data of the distance between the object and the sensing unit 130 from the sensing unit 130 (the first sensing unit 131 is used as an example). The determining unit 200 may determine that the object is moving away from or approaching the first sensing unit 131 based on the time sequence and the identification sensing data. Therefore, the determining unit 200 may identify the gesture content of moving forward and backward. In the embodiment, the identification sensing data may be obtained through only one sensing unit 130. Please refer to Table 1, which shows identification sensing data embodiments. When the determining unit 200 receives the identification sensing data indicating that the distances between the object and the first sensing unit 131 are 5 centimeters (cm), 10 cm and 15 cm respectively from the first time sequence to the third time sequence, the determining unit 200 determines that the moving direction of the object is the direction away from the sensing unit (first sensing unit 131) based on the identification sensing data. The determining unit 200 may identify the gesture content G7 of a first forward and backward movement (the object moves from far to near relative to the projection target 3). The identification method of a gesture content G8 of a second forward and backward movement (the object moves from near to far relative to the projection target 3) is the same as the first forward and backward movement, and therefore will not be described again here.

TABLE 1

| | First time | Second time | Third time | Moving |
|---|---|---|---|---|
| Gesture content | sequence | sequence | sequence | direction |
| Near to far | 5 cm | 10 cm | 15 cm | Away from |
| | | | | sensing unit |
| Far to near | 15 cm | 10 cm | 6 cm | Approach |
| | | | | sensing unit |

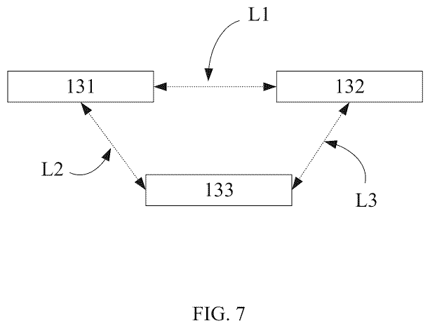

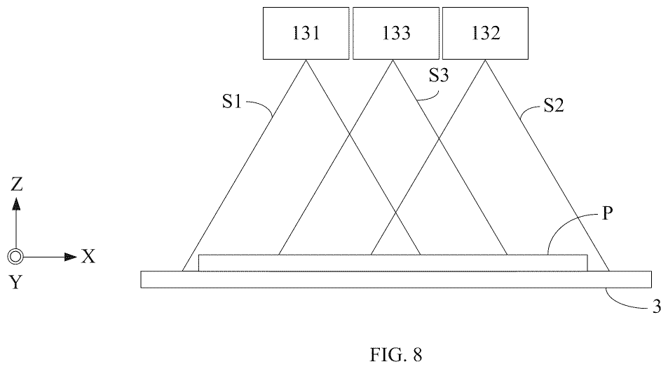

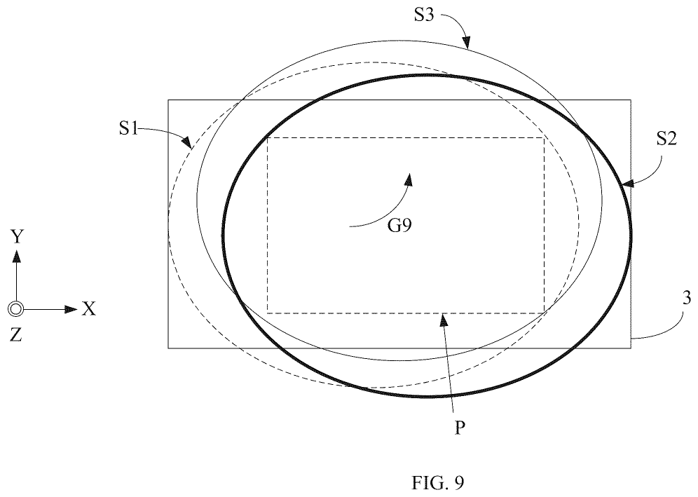

Please refer to FIG. 1, FIG. 7, FIG. 8 and FIG. 9. FIG. 7 is a schematic of the relative positions of sensing units according to an embodiment of the disclosure. FIG. 8 is a schematic of the relative positions of sensing units and a projection target according to an embodiment of the disclosure. FIG. 9 is a schematic of the relationship between the sensing areas of sensing units and the projection area of a projected image according to an embodiment of the disclosure. In the embodiment, the identification module 100 may further include a third sensing unit 133. The third sensing unit 133 is not disposed on the horizontal connection line L1, another horizontal connection line L2 may be defined between the third sensing unit 133 and the first sensing unit 131, and another horizontal connection line L3 may be defined between the third sensing unit 133 and the second sensing unit 132. The horizontal connection line L1, the horizontal connection line L2 and the horizontal connection line L3 do not overlap each other. A sensing area S3 of the third sensing unit 133 partially overlaps with the sensing areas S1 and S2 of the first sensing unit 131 and the second sensing unit 132 respectively. The sensing areas S1, S2, and S3 of the first sensing unit 131, the second sensing unit 132, and the third sensing unit 133 at least partially overlap with the projection area P.

When the projection device 1 implements the gesture identification function, the determining unit 200 is used to perform a linear transformation on the identification sensing data of the object and the first sensing unit 131, the second sensing unit 132 and the third sensing unit 133 respectively to obtain the coordinates of the object. The determining unit 200 may establish two-dimensional coordinates associated with the projection area P based on the projection area P. The determining unit 200 may perform the linear conversion on the identification sensing data (distance data) of the object and the first sensing unit 131, the second sensing unit 132 and the third sensing unit 133 respectively to obtain the coordinate values (coordinate data) of the object in two-dimensional coordinates. Through the continuous change of the coordinates of the object, the determining unit 200 may identify the gesture content. For example, when the X-axis value of the object's coordinates continues to increase and the change value of the Y-axis value of the object's coordinates falls within a preset threshold, it means that the object moves from left to right. The determining unit 200 may identify the gesture content of lateral movement (left to right). In another embodiment, when the X-axis value of the object's coordinates continues to increase, the change value of the Y-axis value of the object's coordinates exceeds the preset threshold, and the change value of the Y-axis value is a geometric sequence relationship, it means that the movement of the object is lateral arc movement. The determining unit 200 may identify the gesture content of lateral arc movement (gesture content G9, as shown in FIG. 9). Thereby, the determining unit 200 may clearly determine the relative position between the object and the projected image based on the coordinate value of the object in the two-dimensional coordinates. In one embodiment, the two-dimensional coordinate information can be pre-stored in the projection device 1. Therefore, the determination unit 200 does not need to create additional two-dimensional coordinates, which effectively reduces the computational load of the determination unit 200.

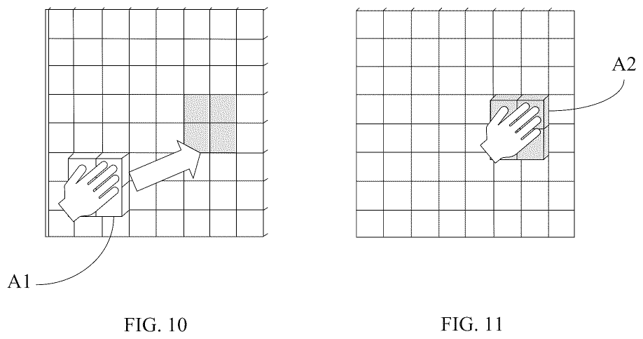

Please refer to FIG. 1, FIG. 10 and FIG. 11. FIG. 10 is a schematic of an identification sensing data according to an embodiment of the disclosure. FIG. 11 is a schematic of an identification sensing data according to another embodiment of the disclosure. In the embodiment in which the sensing unit 130 is implemented by the multi-area sensing unit, the sensing unit 130 generates the depth image data as the identification sensing data. The sensing unit 130 is used to divide the plane of the sensing area into sub sensing areas (for example, 9×9 sub sensing areas). The sensing unit 130 is used to sense the distance between the sub sensing areas and the sensing unit 130 to generate the depth image data according to the sub sensing areas and corresponding distance data. The determining unit 200 identifies the gesture content based on the distance data changes of each sub sensing area in different time series. As shown in FIG. 10, in the first time sequence, the sub sensing areas A1 obscured by the object have a relatively close first distance information with the sensing unit 130. The first distance information is smaller than other distance information of other sub sensing areas, so the sub sensing area A1 forms a raised area in the depth image data. Please refer to FIG. 11. In the second time sequence, the sub sensing area A2 in the depth image data is obscured by the object and has a second distance information, and the second distance information is smaller than the distance information of other sub sensing areas. The determining unit 200 may identify the object moving from left to right through the depth image data generated in the first time sequence and the second time sequence and then identify the gesture content of “left to right”.

In one embodiment, the projection device 1 further includes a storage module 900, as shown in FIG. 1. The storage module 900 is electrically connected to the determining unit 200 and the control module 300. The storage module 900 stores lookup tables and/or two-dimensional coordinate information. The storage module 900 may be a read-only memory, a random access memory or a memory device. The storage module 900 is electrically connected to the control module 300. The determining unit 200 may search the lookup table based on the gesture content and generate the control instruction. Please refer to Table 2, which is an example of a lookup table. For example, when the determining unit 200 identifies that the gesture content is near to far, the determining unit 200 may determine the instruction category corresponding to the gesture content (reduce the brightness of the projection device) in the lookup table. Therefore, the determination unit 200 may generate a control instruction based on the instruction category and provide the control instruction to the control module 300.

TABLE 2

| | Instruction | Command channel |
|---|---|---|
| Gesture content | category | object |
| Near to far | Reduce the | Image |
| (move forward | brightness of the | processing |
| and backward) | projection device | module 510 |
| Far to near | Increase the | Image |
| (move forward | brightness of the | processing |
| and backward) | projection device | module 510 |
| Left to right | Reduce the | Audio processing |
| (lateral movement) | volume of the | module 520 |
| | projection device | |
| Right to left | Increase the | Audio processing |
| (lateral movement) | volume of the | module 520 |
| | projection device | |
| Up to down | Go back to the | Interface |
| (longitudinal movement) | previous video | module 400 |
| | (or slideshow) | |
| Down to up | Go to the next | Interface |
| (longitudinal movement) | video (or slideshow) | module 400 |
| Pause | Pause video/audio | Interface |
| | | module 400 |
| Right after pause | Play video/audio | Interface |
| | | module 400 |

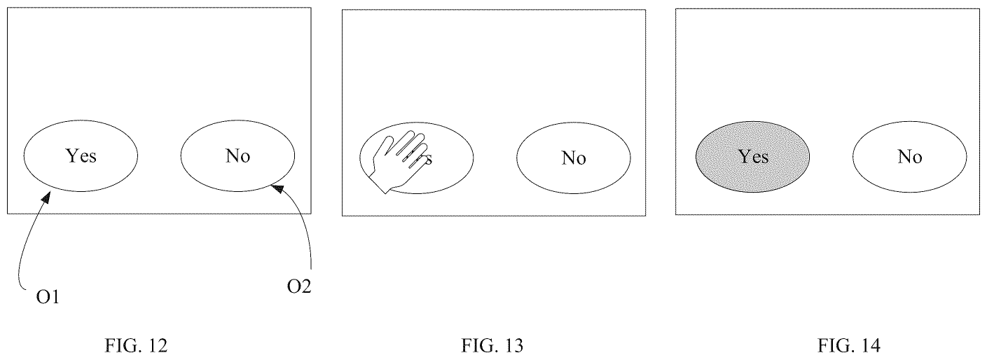

In one embodiment, a control situation of the gesture content may include a one way control situation and an interactive control situation. In the one way control situation, the determining unit 200 identifies the gesture content and generates the corresponding control instructions based on a preset lookup table. In the interactive control situation, the determining unit 200 determines the position of the gesture content based on the projection data including object selection data and the identification sensing data, and generates the control instruction based on the projection data and the position of the gesture content. In this embodiment, the gesture content is pause. For example, the projection data generated by the signal processing module 500 includes the object selection data. The object selection data includes options. The determining unit 200 instantly determines the position where the object stays in the projection area based on the identification sensing data. The determining unit 200 determines whether any option is obscured by the object based on the position of the object and the positions of options in the projected image. When an option in the projected image is obscured by the object, the determining unit 200 generates the control instruction based on the selected option and transmits the control instruction to the control module 300. In one embodiment, the determining unit 200 may identify that the gesture content is “pause” based on a lookup table (for example, Table 2) and generate the control instruction based on the gesture content. Please refer to FIG. 12, FIG. 13 and FIG. 14. FIGS. 12-14 are schematics of an interactive control situation according to embodiments of the disclosure. In FIG. 12, the projected image includes options O1 and O2. In FIG. 13, when the object covers the option O1, the determination unit 200 determines that the object stays in the projection area and covers the option O1 based on the identification sensing data, and the determination unit 200 generates the control instruction. In FIG. 14, based on the control instruction, the control module 300 allows the signal processing module 500 to generate the projected image including notification data to change the color of the option O1 in the projected image. This indicates that option O1 has been selected.

In one embodiment, the projection device 1 further includes a status detection module 800. The status detection module 800 is electrically connected to the control module 300. The status detection module 800 is used to detect the placement status of the projection device 1 and generate status detection data based on the placement status of the projection device 1. The status detection module 800 may include one of an acceleration sensor, a gyroscope and a gravity sensor. The status detection data is, for example, an acceleration value, an angular velocity value or a gravity change value. The control module 300 determines that the status of the projection device 1 is the hanging mode or the forward projection mode based on the status detection data and enables the projection device 1 to implement the gesture identification function and/or the eye protection function.

In another embodiment, the control module 300 may determine whether the status of the projection device 1 is the hanging mode or the forward projection mode based on a status setting information. The status setting information may be pre-stored in the control module 300 or set by the user through an On-Screen Display (OSD) setting interface of the projection device 1. When the control module 300 determines that the status of the projection device projection device 1 is the hanging mode, the control module 300 causes the projection device 1 to implement the gesture identification function. When the control module 300 determines that the projection device 1 is in the forward projection mode, the control module 300 determines that the projection device 1 implements the gesture identification function or the eye protection function based on the function setting information. The function setting information may be a setting information pre-stored in the projection device 1, or the setting information may be input by the user through the On-Screen Display (OSD) setting interface of the projection device 1. In one embodiment, when the status of the projection device 1 is the hanging mode, the control module 300 causes the projection device 1 to implement the gesture identification function, and the projection device 1 cannot be switched to the eye protection function.

In one embodiment, when the projection device 1 implements the eye protection function, the determining unit 200 identifies the corresponding distance content based on the identification sensing data and generates the control instruction based on the distance content. For example, when the determining unit 200 identifies that the distance content is 50 cm, it represents that the distance between the user and the identification module 100 is 50 cm. The determining unit 200 determines that the distance between the user and the identification module 100 is too short. Thus, the determining unit generates the control instruction of “reducing the brightness of the projection device 1”. The control instruction then is provided to the control module 300 by the determining unit 200. Thus, the determining unit 200 may automatically change the original setting of the projection device 1 according to the distance between the user and the projection device 1 to provide a suitable image beam for providing a better viewing experience to the user.

In one embodiment, when the projection device 1 implements the gesture identification function, the control module 300 searches and determines the command channel object of the control instruction in a look up table (such as Table 2) based on the received control instruction. The control instruction is then provided to the command channel object thus determined. The command channel object includes the interface module 400 and the signal processing module 500. For example, when the control module 300 receives the control instruction of “reducing the brightness of the projection device 1”, the control module 300 determines that the command channel object of the control instruction is the image processing module 510 of the signal processing module 500 according to the look up table. Then the control instruction is provided to the image processing module 510 by the control module 300. For example, when the control module 300 receives the control instruction of “reducing the volume of the projection device 1”, the control module 300 determines that the command channel object of the control instruction is the audio processing module 520 of the signal processing module 500 according to the look up table. Then the control instruction is provided to the audio processing module 520 by the control module 300. For example, when the control module 300 receives the control instruction of “pause video/audio”, the control module 300 determines that the command channel object of the control instruction is the interface module 400 according to the look up table. Then the control instruction is provided to the interface module 400 by the control module 300. The control instruction is provided to the interface module 400 by the control module 300 through a communication interface that complies with the High Definition Multimedia Interface (HDMI) specification. In one embodiment, the control instruction is provided to the interface module 400 through a consumer electronics control (CEC) channel.

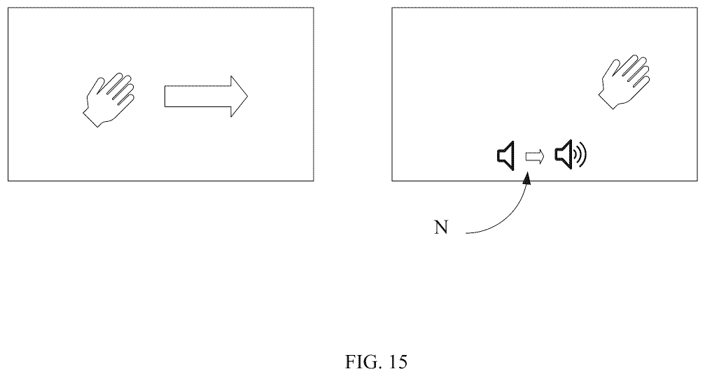

In one embodiment, the control module 300 receives the control instruction and generates notification data instruction based on the control instruction. The control instruction and the notification data instruction is provided to the signal processing module 500. The signal processing module 500 generates projection data or/and audio data comprising notification data N based on the control instruction and the notification data instruction. The notification data N is used to indicated that a function of the gesture content (the control instruction) is complete. Please refer to FIG. 15. In one embodiment, when the determining unit determines that the gesture content is “left to right” and generates the control instruction of “increasing the volume of the projection device”, the control module 300 generates the notification data instruction corresponding to increasing the volume of the projection device 1. In another embodiment, the control module 300 generates the notification data instruction corresponding to one of the options in response to the gesture content corresponding to one of the options. Therefore, the signal processing module 500 generates the audio data based on the control instruction to increase the volume of the projection device 1 and further adds the notification data N on the projection data base on the notification data instruction. Therefore, the user may be prompted that the function of the gesture content is completed by the notification data in the projected image.

In one embodiment, the signal processing module 500 includes the image processing module 510 and the audio processing module 520, as shown in FIG. 1. The image processing module 510 is electrically connected to the control module 300, the interface module 400 and the projection module 600. The image processing module 510 may be an image processor, an image signal processor, image processing integrated circuit or processing circuit, etc., The interface module 400 receives the control instruction from the control module 300 and the input image data from the interface module 400. The image processing module 510 adjusts the brightness, color temperature, color and/or the projected image scaling based on the control instruction. The image processing module 510 generates the projection data based on the adjusted input image data. Thus, the image processing module 510 may generate the projection data based on the input image data and the control instruction. In one embodiment, the image processing module 510 adds a plurality of object selection data on the input image data based on the control instruction to generate the projection data including the options. In one embodiment, the image processing module 510 generates the projection data including the notification data by adding the notification data on the input image data based on the notification data instruction. In the embodiment in which the projection data includes options, the notification data is used to indicate that one of the options is selected. The audio processing module 520 is electrically connected to the control module 300, the interface module 400 and the audio module 700. The audio processing module 520 may be an audio processor, an audio processing integrated circuit, an audio processing circuit, etc. The audio processing module 520 receives the control instruction from the control module 300 and the input audio data from the interface module 400. The audio processing module 520 adjusts the volume, the mute activation or deactivation and/or the audio playback mode of the input audio data based on the control instruction. The audio processing module 520 generates the audio data based on the adjusted input audio data. Thus, the processing module 520 may generate the audio data based on the input audio data and the control instruction. In one embodiment, the processing module 520 generates the audio data including the notification data based on the notification data instruction. For example, the processing module 520 may generate audio data generating a notification sound “Ding”.

In one embodiment, the interface module 400 includes a front-end processor 410 and an interface terminal 420, as shown in FIG. 1. The interface module 400, for example, may comprise at least one processor and at least one interface terminal. The front-end processor 410 is electrically connected to the interface terminal 420. The front-end processor 410 is electrically connected to the control module 300 and/or the signal processing module 500. The front-end processor 410 receives the control instruction from the control module 300. The control instruction is provided to the interface terminal 420 by the front-end processor 410. The front-end processor 410 receives the input data from the interface terminal 420 and executes pre-processing on the input data. The pre-processed input data is provided to the image processing module 510 and/or the audio processing module 520 of the signal processing module 500. When the input data is the input image data, the input image data is provided to the image processing module 510. When the input data is the input audio data, the input audio data is provided to the audio processing module 520. The interface terminal 420 is electrically connected to the front-end processor 410 and the signal source 2. The interface terminal 420 receives the control instruction from the front-end processor 410 and the control instruction is then provided to the signal source 2. The interface terminal 420 receives the input data from the signal source 2, and the input data is provided to the front-end processor 410. The front-end processor 410 may be implemented by a front-end processor that complies with the High-Definition Multimedia Interface (HDMI) specification, the Video Graphics Array (VGA) specification, or the Universal Serial Bus (USB) TYPE-C specification. The front-end processor 410 includes an HDMI front-end processor 410a, a VGA front-end processor 410b, and a TYPE-C front-end processor 410c. The interface terminal 420 may be implemented by an interface that complies with the High-Definition Multimedia Interface (HDMI) specification, the Video Graphics Array (VGA) specification, or the Universal Serial Bus (USB) TYPE-C specification. The interface terminal 420 includes an HDMI interface 420a, a VGA interface 420b, and a TYPE-C interface 420c. For example, the interface module 400 may comprise High-Definition Multimedia Interface (HDMI), the Video Graphics Array (VGA), the Universal Serial Bus (USB) TYPE-C, etc.

In an embodiment in which the front-end processor 410 and the interface terminal 420 comply with the High-Definition Multimedia Interface (HDMI) specifications, the front-end processor 410 receives the control instruction from the control module 300 through the CEC channel, and the interface terminal 420 transmits the control instruction to the signal source 2 through the CEC channel. Thus, the signal source 2 may operate in response to the control instruction to update the input data. For example, in the one way control situation, the control instruction may be generated based on the instruction category in the look up table. In the interactive control situation, the control instruction may be an instruction used to instruct the signal source 2 to perform an operation corresponding to the coordinate information. The signal source 2 provides the input image data including the object selection data. The projection device 1 generates the projected image including options based on the input image data. The signal source 2 initiates an object coordinate request through the CEC channel. The determining unit 200 obtains an object coordinate information and the gesture content (such as pause) based on identification sensing data. The determining unit 200 transmits the control instruction including the object coordinate information to the control module 300. The control instruction from the control module 300 is transmitted to the signal source 2 through the CEC channel. The signal source 2 operates corresponding to the received object coordinate information. For example, the signal source 2 pauses the playback of a video or an audio being played by the signal source 2 according to the option selected. The signal source 2 transmits the current image displayed and/or audio as the updated input data to the interface terminal 420. In one embodiment, the signal source 2 searches in a look up table based on the received coordinate information to determine whether one of the options is selected. Please refer to Table 3. Table 3 is an embodiment of an object coordinate list. Each of the options corresponds to a rectangular coordinate range defined by a first endpoint coordinate and a second endpoint coordinate. For example, the first endpoint coordinate of option 1 is (1, 5), and the second endpoint coordinate of option 1 is (5, 1). Thus, the rectangular coordinate range is defined between the first endpoint coordinate (1, 5) and the second endpoint coordinate (5, 1). The signal source 2 determines whether the coordinate information is in the rectangular coordinate range. When the coordinate information is in the rectangular coordinate range, it represents that the corresponded option is selected by the user. For example, the input image data of the signal source 2 includes option 1, option 2 and option 3. After the signal source 2 receives the coordinate information, the signal source 2 determines if the coordinate information is in the rectangular coordinate range of option 1, option 2 or option 3. When the coordinate information is in the rectangular coordinate range of option 1, the signal source 2 determines that the selected option is option 1 and operates according to option 1. In another embodiment, the object coordinate list is stored in the projection device 1. For example, the object coordinate list is stored in the storage module 900. Thus, the determining unit 200 may search the look up table to determine whether the coordinate information is in one of the rectangular coordinate ranges. When the coordinate information is in one of the rectangular coordinate ranges, the determining unit 200 provides the control instruction including an option information to the signal source 2 through the control module 300. For example, the option information of option 1 is provided to the signal source 2 through the control module 300.

TABLE 3

| Option serial | First endpoint | Second endpoint |
|---|---|---|
| number | coordinate | coordinate |
| Option 1 | Xa1, Ya1 | Xb1, Yb1 |
| Option 2 | Xa2, Ya2 | Xb2, Yb2 |
| Option 3 | Xa3, Ya3 | Xb3, Yb3 |

In one embodiment, the audio module 700 includes an audio amplification module 710 and a speaker device 720. For example, the audio module 700 comprises at least one circuit or chip or an integrated circuit for processing the audio data and at least one speaker for playing sound. The audio amplification module 710 is electrically connected to the audio processing module 520 and the speaker device 720 (such as a speaker). The audio amplification module 710 may be an amplifier circuit, an amplifier chip or an amplifier integrated circuit. The audio amplification module 710 receives the audio data and executes power amplification processing on the audio data. The speaker device 720 is electrically connected to the audio amplification module 710 for receiving the amplified audio data and playing sound based on the audio data.

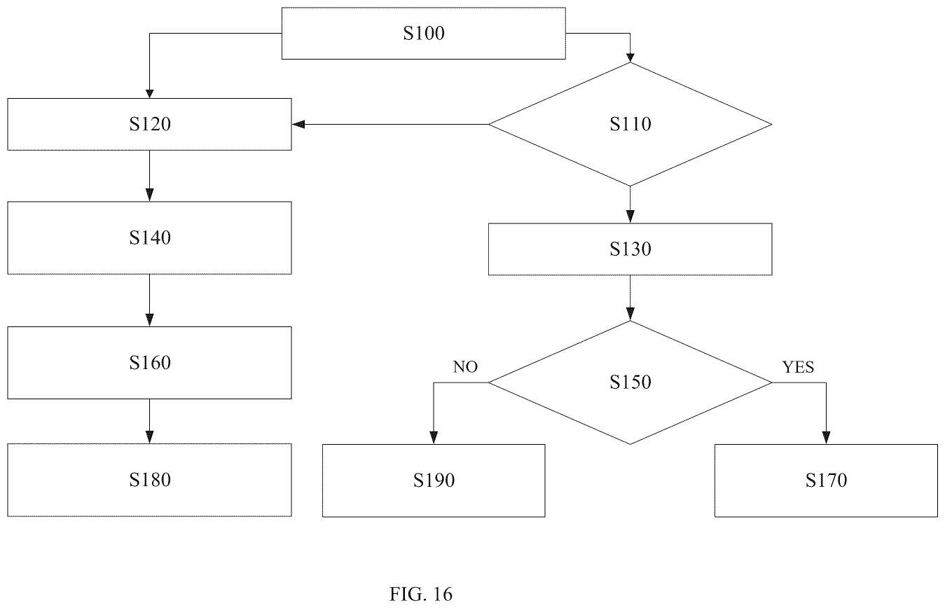

Please refer to FIG. 1 and FIG. 16. FIG. 16 is a schematic of a flow chart of a control method of a projection device according to an embodiment of the disclosure. The control method may be implemented by the projection device 1 of FIG. 1. The control method includes the steps S100 to S190.

In step S100, the status of the projection device 1 is obtained by the control module 300. In one embodiment, the status detection module 800 detects the placement status of the projection device 1, generates the status detection data according to the placement status of the projection device 1 and provides the status detection data to the control module 300. The control module 300 determines whether the projection device 1 is in the hanging mode or in the forward projection mode based on the status detection data. In one embodiment, the control module 300 may obtain the status of the projection device 1 based on the status setting information. The status setting information may be stored in the control module 300 or input by the user through the setting interface of the On-Screen Display (OSD) of the projection device 1. In step S110, when the control module 300 determines that the status of the projection device 1 is the hanging mode, the control module 300 causes the projection device 1 to implement the gesture identification function. Then the control method continues to step S120. In step S110, when the control module 300 determines that the status of the projection device 1 is the forward projection mode, the control module 300 determines that the projection device 1 implements the gesture identification function according to the function setting information, and then the control method continues to step S120. In step S110, when the control module 300 determines that the status of the projection device 1 is the forward projection mode, the control module 300 determines that the projection device 1 implements the eye protection function according to the function setting information, and then the control method continues to step S130.

The gesture identification function further includes the one way control situation, and the one way control situation includes the steps S140 to S180. In step S140, the determining unit 200 receives the identification sensing data from the identification module 100, identifies the gesture content based on the identification sensing data, and generates the control instruction based on the gesture content. The control instruction is provided to the control module 300. The determining unit 200 identifies the gesture content based on the distance data in different time series. In one embodiment, the determining unit 200 searches the control instruction in the look up table and generates the control instruction based on the gesture content. In step S160, the control module 300 determines the command channel object of the control instruction and transmits the control instruction to the corresponding command channel object. The command channel object is at least one of the interface module 400 and the signal processing module 500. In one embodiment, the control module 300 generates the notification data instruction based on the control instruction and transmits the control instruction to the corresponding command channel object. In step S180, the signal processing module 500 generates the projection data and/or the audio data. In one embodiment, in response to the command channel object being the signal processing module 500, the image processing module 510 of the signal processing module 500 receives the control instruction. The image processing module 510 adjusts the brightness, color temperature, color and/or projected image scaling of the input image data according to the control instruction and generates the projection data based on the adjusted input image data. In one embodiment, the image processing module 510 adds a plurality of object selection data on the input image data based on the control instruction to generate projection data including a plurality of options. In one embodiment, the image processing module 510 adds the notification data on the input image data based on the notification instruction to generate projection data including the notification data. The notification data indicates that the control instruction corresponding to the gesture content input by the user is executed. In one embodiment, in response to the command channel object being the signal processing module 500, the audio processing module 520 of the signal processing module 500 receives the control instruction. The audio processing module 520 adjusts the volume, the mute activation or deactivation and/or the audio playback mode of the input audio data based on the control instruction and generates the corresponding audio data based on the adjusted input audio data. In one embodiment, the audio processing module 520 generates the audio data including the notification data based on the notification data instruction. In one embodiment, in response to the command channel object being the interface module 400, the signal source 2 receives a control signal through the interface module 400 and operates corresponding to the control signal. The operation includes, for example, at least one of switching pages, pausing audio and/or video, going to the previous page, going to the next page, playing the previous song, playing the next song, etc. Thus, the input data provided to the interface module 400 is updated accordingly. Therefore, the projection module 600 may generate the corresponding image beam based on the projection data generated by the signal processing module 500 so as to form the corresponding projected image on the projection target through the image beam. Also, the audio data may be played through the audio module 700. Therefore, the purpose of controlling or setting the projection device 1 and/or the signal source 2 through the gesture content control may be achieved.

After the step S130, the control method continues to step S150. In the step S150, the determining unit 200 receives identification sensing data from the identification module 100 and identifies the corresponding distance content based on the identification sensing data, and the determining unit 200 determines whether to adjust the initial setting of the projection device based on the distance content to generate the corresponding control instruction. The initial setting is, for example, the original display setting of the projection device 1 or the display setting at startup. When the determining unit 200 determines that the initial settings of the projection device 1 need to be adjusted, step S170 is executed, and the determining unit 200 generates a corresponding control instruction. The control instruction is, for example, “reduce the brightness of the projection device”, and the control module 300 provides the control instruction to the corresponding command channel object. The operation of the command channel object is as described above, so it is not described again here. Therefore, the projection device 1 generates the projected image after changing the initial settings. For example, the projection device 1 may produce the projected image with reduced brightness. When the determining unit 200 determines that there is no need to adjust the initial settings of the projection device, the determining unit 200 does not generate the control instruction, and the projection device 1 generates the projected image with the initial settings. In this way, the projection device 1 may provide a suitable projected image according to the position of the object (human body, hand and/or indicator), allowing the user to have a better user experience.

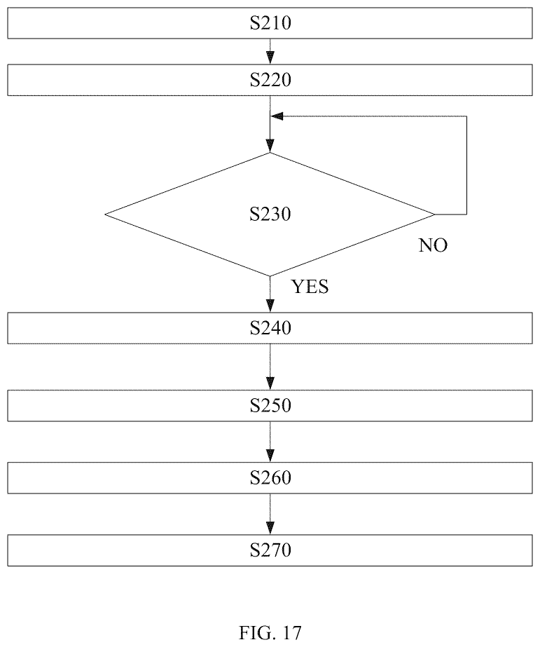

The gesture identification function further includes the interactive control situation, as shown in FIG. 17. The interactive control situation includes the following steps. After step S120, the control method continues to step S210. In step S210, the signal processing module 500 generates the projection data based on the input data and the object selection data. In one embodiment, the image processing module 510 adds object selection data on the input image data to generate projection data including options. In one embodiment, the signal source 2 provides the input image data including the object selection data, and the image processing module 510 generates the projection data including options based on the input image data. In step S220, the projection module 600 generates the image beam based on the projection data, and the image beam forms the projected image including the option on the projection target. In step S230, the determining unit 200 obtains the position (gesture content) of the object based on identification sensing data, and the determining unit 200 and/or signal source 2 determines whether the option of the object selection data is obscured based on the position of the object. In this example, the gesture content indicates that the object is pause. In one embodiment, the determining unit 200 determines whether any option is obscured by the object based on the position of the object in the projection area and the positions of options in the projected image. For example, when the position of an object in the projection area overlaps the position of an option in the projected image, the option is obscured. In one embodiment, the determining unit 200 and/or the signal source 2 may determine whether the coordinates fall within the rectangular coordinate range of the option and determine whether the option of the object selection data is obscured. When no option is obscured, no option is selected by the user, so step S230 is executed until the option is obscured (selected). When one of the options is selected, the control method continues to step S240. In step S240, the determining unit 200 generates the control instruction based on the selected option and transmits the control instruction to the control module 300. The control module 300 transmits the control instruction corresponding to the option to the signal processing module 500 and/or signal source 2. In step S250, the signal processing module 500 generates the projection data and/or audio data including notification data. The notification data is used to indicate that an option has been selected. In one embodiment, the control module 300 may generate the notification data instructions based on the control instruction. The image processing module 510 may add the notification data on the input image data based on the notification data instruction and generate the projection data including the notification data. In one embodiment, the audio processing module 520 generates the audio data including the notification data based on the notification data instruction. In step S260, the projection module 600 generates the image beam based on the projection data, and the image beam forms the projected image including the option and the notification data on the projection target. The audio module 700 plays the audio data, and the audio data includes the notification data. In this way, by including the notification data in the projected image and/or audio data, the user may be prompted that the projection device 1 has recognized the option selected by the user. In step S270, the signal processing module 500 or the signal source 2 executes an operation corresponding to the option according to the received control instruction. In this way, the user may control the projection device 1 and/or the signal source 2 by interacting with the projected image through gestures, thereby improving the convenience of controlling or setting the projection device 1 and signal source 2.

According to the above, the embodiments of the disclosure at least have one of the following beneficial effects: Without increasing additional hardware costs, the projection device and the control method according to the embodiment of the invention allow the user to easily control or adjust the settings of the projection device and the external signal source that provides image data through gesture changes.

The above description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode of practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may use “first”, “second”, etc. followed by a noun or element. Such terms should be understood as nomenclature and should not be construed as giving the limitation on the number of the elements modified by such nomenclature unless a specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element or component in the disclosure is intended to be dedicated to the public regardless of whether the element or component is explicitly recited in the following claims.

What is claimed is:

1. A projection device electrically connected to a signal source, comprising:
an identification module, configured to generate identification sensing data;
a determining unit, electrically connected to the identification module, configured to receive the identification sensing data in response to the projection device implementing a gesture identification function, identify a gesture content based on the identification sensing data, and generate a control instruction based on the gesture content;
a control module, electrically connected to the determining unit, configured to receive the control instruction and determine a command channel object of the control instruction;
an interface module, electrically connected to the control module and the signal source, configured to receive input data from the signal source and the control instruction from the control module, wherein the interface module is configured to transmit the control instruction to the signal source to enable the signal source to operate according to the control instruction;
a signal processing module, electrically connected to the control module and the interface module, configured to receive the control instruction from the control module and the input data from the interface module, generate at least one of projection data and audio data based on the control instruction and the input data, wherein the command channel object is at least one of the interface module and the signal processing module;
a projection module, electrically connected to the signal processing module, configured to receive the projection data and provide an image beam based on the projection data; and
an audio module, electrically connected to the signal processing module, configured to receive the audio data and output sound based on the audio data.

2. The projection device as claimed in claim 1, further comprising:
a status detection module, electrically connected to the control module, configured to generate status detection data, wherein the control module is configured to receive the status detection data and determine, based on the status detection data, whether the projection device implements the gesture identification function or an eye protection function;
wherein, in response to the projection device implementing the gesture identification function, at least one of the projection data and the audio data comprises notification data, and the notification data indicates that the function of the control instruction is completed;
wherein, in response to the projection device implementing the eye protection function, the determining unit is configured to identify a corresponding distance content based on the identification sensing data, and the determining unit is configured to generate the control instruction based on the distance content.

3. The projection device as claimed in claim 2, wherein the control module is configured to receive the status detection data and determine, based on the status detection data, whether the status of the projection device is a hanging mode or a front projection mode; wherein in response to the projection device being in the hanging mode, the control module is configured to allow the projection device to implement the gesture identification function.

4. The projection device as claimed in claim 3, wherein in response to the projection device being in the front projection mode, the control module is configured to determine whether the projection device implements the gesture identification function or the eye protection function based on a function setting information.

5. The projection device as claimed in claim 2, wherein the status detection module is an acceleration sensor, a gyroscope or a gravity sensor.

6. The projection device as claimed in claim 1, the identification module further comprising:
a gesture identification module, electrically connected to the determining unit, configured to generate gesture identification sensing data; and
an eye protection identification module, electrically connected to the determining unit, configured to generate distance identification sensing data;
wherein, in response to the projection device implementing the gesture identification function, the determining unit is configured to receive the gesture identification sensing data;
wherein, in response to the projection device implementing the eye protection function, the determining unit is configured to receive the distance identification sensing data.

7. The projection device as claimed in claim 6, wherein the gesture identification module and the eye protection identification module are the same identification module, and the identification sensing data generated by the identification module are the gesture identification sensing data or the distance identification sensing data.

8. The projection device as claimed in claim 1, wherein the identification module comprises a first sensing unit and a second sensing unit, wherein a horizontal connection line is defined between the first sensing unit and the second sensing unit, wherein the sensing areas of the first sensing unit and the second sensing unit are at least partially non-overlapping, wherein the determining unit is configured to identify the gesture content based on distance data, the distance data corresponds to a distance between an object and the first sensing unit and a distance between the object and the second sensing unit respectively.

9. The projection device as claimed in claim 8, wherein the identification module comprises a third sensing unit, wherein the third sensing unit is not disposed on the horizontal connection line, and the sensing areas of the first sensing unit, the second sensing unit and the third sensing unit at least partially overlap.

10. The projection device as claimed in claim 9, wherein the determining unit is configured to perform a linear transformation on the distance data of the object and the first sensing unit, the object and the second sensing unit and the object and the third sensing unit to obtain coordinates of the object.

11. The projection device as claimed in claim 1, wherein the identification module comprises one or more single area sensing units or multi-area detection units.

12. The projection device as claimed in claim 1, wherein each of the identification sensing data is distance data, and the determining unit is configured to identify the gesture content based on the distance data in different time series.

13. The projection device as claimed in claim 1, wherein the signal processing module comprises:
an image processing module, electrically connected to the control module, the interface module and the projection module, configured to receive the control instruction from the control module and the input data from the interface module and generate the projection data based on the control instruction and the input data; and
an audio processing module, electrically connected to the control module, the interface module and the audio module, configured to receive the control instruction from the control module and the input data from the interface module and generate the audio data based on the control instruction and the input data.

14. The projection device as claimed in claim 1, wherein the interface module comprises:
a front-end processor, electrically connected to the control module and the signal processing module, configured to receive the control instruction from the control module and the input data from the signal source and preprocess the input data; and
an interface terminal, electrically connected to the front-end processor and the signal source, configured to transmit the control instruction from the control module to the signal source and transmit the input data from the signal source to the front-end processor.

15. The projection device as claimed in claim 1, wherein the projection data generated by the signal processing module comprises object selection data, the object selection data comprises options, wherein in response to the gesture content corresponding to one of the options, the projection data comprises notification data indicating that the option is selected, and the control instruction corresponds to the option.

16. A control method for a projection device, wherein the projection device is electrically connected to a signal source, the projection device comprises a determining unit, a control module, an interface module, a signal processing module, a projection module and an audio module, and the control method comprising:
in response to the projection device implementing a gesture identification function, identifying a gesture content based on identification sensing data and generating a control instruction based on the gesture content by the determining unit;
determining a command channel object of the control instruction through the control module, wherein the command channel object is at least one of the interface module and the signal processing module;
receiving input data from the signal source by the interface module, and transmitting the control instruction to the signal source through the interface module to enable the signal source to operate according to the control instruction;
generating at least one of projection data and audio data through the signal processing module based on the input data and the control instruction;
providing an image beam based on the projection data through the projection module; and
outputting sound based on the audio data through the audio module.

17. The control method as claimed in claim 16, wherein the projection device further comprises a status detection module, the control method further comprises:
generating status detection data through the status detection module;
determining the projection device implementing the gesture identification function or an eye protection function based on the status detection data through the control module;
in response to the projection device implementing the gesture identification function, indicating a function of the control instruction by notification data, wherein at least one of the projection data and the audio data comprises the notification data; and
in response to the projection device implementing the eye protection function, identifying a corresponding distance content based on the identification sensing data and generating the control instruction based on the distance content through the determining unit.

18. The control method as claimed in claim 17, wherein in response to the control module determining the projection device in a hanging mode based on the status detection data, determining the projection device implementing the gesture identification function through the control module, wherein in response to the control module determining the projection device in a forward projection mode based on the status detection data, determining the projection device implementing the gesture identification function or the eye protection function based on a function setting information through the control module.

19. The control method as claimed in claim 16, further comprising:
identifying the gesture content based on distance data of the identification sensing data in different time series through the determining unit.

20. The control method as claimed in claim 16, further comprising:
identifying the gesture content according to distance data of an object and a first sensing unit and distance data of the object and a second sensing unit respectively through the determining unit.

21. The control method as claimed in claim 20, further comprising:
obtaining coordinates of the object by performing a linear transformation on the distance data of the object and the first sensing unit, the distance data of the object and the second sensing unit and distance data of the object and a third sensing unit respectively through the determining unit.

22. The control method as claimed in claim 16, further comprising:
generating the projection data based on the input data and object selection data through the signal processing module, wherein the object selection data comprises a plurality of options;
providing the image beam based on the projection data through the projection module; and
in response to one of the options corresponding to the gesture content is obscured, generating the control instruction based on the gesture content through the determining unit.

23. The control method as claimed in claim 16, comprising:
in response to the command channel object being the interface module, the signal source updates the input data corresponding to the control instruction.
